(19) United States
(12) Patent Application Publication
(10) Pub. No.: US 2014/0322688 A1
(43) Pub. Date: Oct. 30, 2014

(54) SYSTEM FOR EVALUATING CARDIAC SURGERY TRAINING

(71) Applicant: EBM Corporation, Tokyo (JP)

(72) Inventors: Young Kwang PARK, Tokyo (JP); Yasuyuki SHIRAISHI, Tokyo (JP)

(73) Assignee: EBM Corporation, Tokyo (JP)

(21) Appl. No.: 14/198,533

(22) Filed: Mar. 5, 2014

Related U.S. Application Data
(63) Continuation-in-part of application No. 12/921,462, filed on Feb. 14, 2011, now abandoned.

(30) Foreign Application Priority Data
Mar. 3, 2006 (JP) 2006-057196

(51) Int. Cl. G09B 23/30

(52) U.S. Cl. CPC G09B 23/303
USPC 434/268

(57) ABSTRACT

A system for evaluating training 1 comprises a pulsating flow generating unit 11 for imparting a pulsating flow to a designated fluid, a coronary artery flow generating unit 12 that branches off from that pulsating flow generating unit 11 and by which a flow condition of that pulsating flow can be converted to generate a coronary artery flow, and a surgery training unit 13 provided between the pulsating flow generating unit 11 and the coronary artery flow generating unit 12 and that operates to enable coronary artery bypass surgery training under pulsation. This system for evaluating training 1 has a circuit configured to enable the coronary artery flow fluid generated by the coronary artery flow generating unit 12 to pass through a simulated blood vessel that has been subjected to a designated treatment in training using the surgery training unit 13.

### CROSS REFERENCE TO RELATED APPLICATIONS

This application is a continuation-in-part of U.S. patent application Ser. No. 12/921,462, filed on Feb. 14, 2011, which is a national phase application of PCT application No. PCT/JP2007/054034, filed on Mar. 2, 2007, which claims priority from Japanese Patent Application Serial No. 2006-057196, filed on Mar. 3, 2006. The entire disclosure of the aforesaid application is incorporated herein by reference.

### FIELD OF THE INVENTION

The present invention relates to a system for evaluating cardiac surgery training and more specifically, to a system that enables cardiac surgery training such as coronary artery bypass surgery under pulsation to be performed the same way as in a real operation and that enables appropriate evaluation of the training results.

### BACKGROUND OF THE INVENTION

Arteries called coronary arteries are distributed over the human myocardium. The narrowing and occlusion of the coronary arteries leads to myocardial necrosis called myocardial infarction. Remedies are available for such coronary artery narrowing and occlusion, where coronary artery bypass surgery is performed to establish a new alternative path for the coronary arteries thereby bypassing the narrowed and occluded vascular sites. Coronary artery bypass surgery is performed with the heart temporarily arrested to facilitate the procedure, often with the use of an artificial cardiopulmonary device that maintains the patient's blood circulation state. However, the use of the cardiopulmonary device at times result in cases of brain disorders and the like with a postoperative decline in cardiac function or a change in the bloodstream, which makes it desirable to perform the above operation, without an artificial cardiopulmonary device, while the patient's heart is in the pulsating state. However, the heart in the pulsating state makes it difficult to perform procedures such as incision and anastomosis on the coronary arteries distributed over the myocardium, where very high surgical skills are required of the physicians. In other words, performing coronary surgery without arresting the patient's heart requires physicians to be proficient, making it necessary for the physicians to be fully trained.

It is noted that a simulator for surgery training has been proposed for training in surgery of the pulsating heart (see Japanese Unexamined Patent Application No. 2005-202267). This simulator is structured such that the rotation of a motor, via a transmission mechanism connected thereto, causes an eccentric rotation of an oscillation means installed in a simulated heart, thereby causing the surface of the simulated heart to pulsate.

However, said simulator structured such that the eccentric rotation of the oscillation means driven by the motor causes the surface of the simulated heart to pulsate, thereby generating only a relatively simple pulsating motion lacking in variation of said surface. In actual human heart pulsations, the heart surface undergoes complex motions, which vary depending on the pathological condition. Reproducing such motions with said simulator will further require adding more motors, transmission mechanisms connected to said motors, and oscillation means, so as to make each of the oscillation means operate independently. This will lead to complex and massive mechanisms including motors and the like and in turn, to an increase in number of part items, thereby resulting in an overall larger device with increased production costs.

Furthermore, even if trained in coronary artery bypass surgery using such a simulator, there is at present no way to evaluate the anastomotic quality resulting from the training by taking into consideration the actual condition in which the blood stream passes through. In other words, there is no means available to evaluate whether the flow condition through the simulated vessels is normal or not, when two simulated blood vessels are used and they are anastomosed for training in coronary artery bypass surgery followed by passing a fluid which has the same flow pattern as that in the human coronary arteries through the anastomosed blood vessel. If an anomaly is found in the blood stream within the anastomosed blood vessel, this will trigger secondary disorders such as thrombus formation. Accordingly, it is important for improvement of the trainee's manipulative skill to be able to judge whether a correct treatment was performed or not by passing a fluid of a flow pattern equivalent to that of the coronary arteries through the simulated blood vessel after the training, and evaluating the fluid's flow condition in the simulated blood vessels.

Since the blood stream in the human coronary arteries, i.e., coronary artery flow, has a unique flow pattern different from that of aortic flow immediately after being pumped out of the heart, the generation of such a coronary artery flow requires the use of a converter, which has already been proposed by the present applicants in Japanese Patent Application No. 2004-314915.

The present invention was conceived in view of such problems, and an object thereof is to provide a system for evaluating training in cardiac surgery that enables cardiac surgery training such as bypass surgery of coronary arteries under pulsation, in conditions close to the real surgery situation, and, further, that enables accurately evaluating the training results in conditions matching an actual post surgery situation by passing a fluid to the site resulting from the training under conditions approaching those of the human bloodstream.

Another object of the present invention is to provide a system for evaluating cardiac surgery training that enables training in bypass surgery of coronary arteries under pulsation in a relatively simple motor-less configuration.

### SUMMARY OF THE INVENTION

(1) A system for evaluating cardiac surgery training, having a pulsating flow generating unit that imparts a pulsating flow to a designated fluid; a coronary artery flow generating unit that converts the pulsating flow generated in the pulsating flow generating unit into a coronary artery flow; and a surgery training unit which operates to enable cardiac surgery training under pulsation, wherein a circuit is configured to enable the coronary artery flow fluid generated by the coronary artery flow generating unit to pass through a training blood vessel that has been subjected to a designated treatment in training using the surgery training unit.

(2) According to another aspect of the invention, the coronary artery flow generating unit imparts suction force to the pulsating flow generated with the pulsating flow generating unit, thereby converting the pulsating flow into the coronary artery flow.

(3) According to still another aspect of the invention, the surgery training unit has an object to be treated that holds operable a training object including the training blood vessel, and a control unit that controls the operation of the training object, wherein the object to be treated, so as to make the training object movable relative to a predetermined region, has an operating mechanism that connects, relatively movably, a member on the predetermined region side and a member of the training object side; and a connector member connected between each of the members, wherein the connector member is formed of a shape memory material, which is contractible with respect to its original shape when an electric current is passed therethrough, wherein the control unit comprises a drive signal generating means that supplies the electric current at a designated timing to the connector member, wherein the drive signal generating means performs controlling an operation of the operation mechanism by varying the condition in which the electric current is supplied to the connector member, thereby changing the shape of the connector member.

(4) According to yet another aspect of the invention, a pressure gauge is mounted that is capable of measuring the pressure loss of the fluid passing through the training blood vessel.

In accordance with the above-mentioned configurations (1) and (2), the surgery training unit operating to enable cardiac surgery such as bypass surgery of coronary arteries under pulsation allows training that conducts a designated procedure such as an anastomosis on a training blood vessel, enabling the coronary artery bypass surgery training in a condition approaching that of an actual surgery situation due to the passing of said coronary artery flow fluid generated by the coronary artery flow generating unit; and also enabling evaluating the anastomosed site resulting from the training under human blood flow conditions, thereby allowing for more accurate evaluations.

The above-mentioned configuration (3) enables operating the training object, in a motor-less manner, by supplying an electric current to the connector members, thereby making use of deformations of the connector members. Herein, variously selecting the conditions in which the connector members are connected with respect to the holder thereby controlling independently the supply of electric current to those connector members, enables giving the training object complex motions, which enables simulation of complex movements over heart surfaces in accordance with conditions such as pathological conditions and the like. Since this can be achieved without using a motor and a transmission mechanism thereof, by adjusting a program module and/or operating a circuit for controlling the supply of electric current, a simple configuration makes it possible to cause the training object to undergo a variety of complex movements and to achieve overall device miniaturization and cost reduction due to a reduction in the number of parts thereof.

According to the above-mentioned configuration (4), adequacy of treatments can be precisely evaluated in that with the pressure losses within the blood vessel, the bloodstream will stagnate and induce thrombus formation. Thus, measuring pressure loss of the fluid in the training object blood vessel treated with anastomosis and the like by surgery training will enable assessing whether the interior of the training blood vessel is in a condition to induce thrombus or not.

### BRIEF DESCRIPTION OF THE DRAWINGS

FIG. 1 is a schematic configuration view of a system for evaluating training for coronary artery bypass surgery in accordance with an embodiment of the present invention;

FIG. 2 is an expanded view of essential parts of FIG. 1;

FIG. 3 shows a flow rate wave pattern representing human aortic flow;

FIG. 4 shows a flow rate wave pattern representing human coronary artery flow;

FIG. 5 shows a flow rate wave pattern in a simulated blood vessel with a pulsating flow generator in operation and a coronary artery flow generating unit not in operation;

FIG. 6 is a schematic configuration view of a surgery training unit;

FIG. 7 is a schematic perspective view of bypass surgery of coronary arteries under pulsation of a training unit;

FIG. 8 is a schematic front view of an object to be treated;

FIG. 9 is a schematic side view of an object to be treated;

FIG. 10 is a cross-sectional view along line A-A of FIG. 8;

FIG. 11 is a schematic plan view of an object to be treated;

FIG. 12 is a schematic perspective view of a training unit according to a modified example for a surgery training unit;

FIG. 13 is a partially exploded expanded perspective view of a drive unit forming a top portion of an object to be treated;

FIG. 14 is a schematic cross-sectional front view conceptually showing a drive unit; and

FIG. 15 is a schematic cross-sectional side view conceptually showing a drive unit.

FIG. 16 is a schematic configuration view showing a controller;

FIG. 17 is a schematic configuration view showing a drive unit of another embodiment;

FIG. 18 is a schematic configuration view showing a drive unit of another embodiment and a schematic configuration view showing a controller;

FIG. 19 is a view for illustrating the behavior of the simulated blood vessels;

FIG. 20 is a view showing a movement locus of the simulated blood vessels;

FIG. 21 is a view showing a movement locus of the simulated blood vessels; and

FIG. 22 A to FIG. 22C are views showing the behavior of the simulation body that holds the simulated blood vessels.

### DETAILED DESCRIPTION OF THE INVENTION

With reference to the accompanying, exemplary drawings, embodiments of the present invention will be explained below.

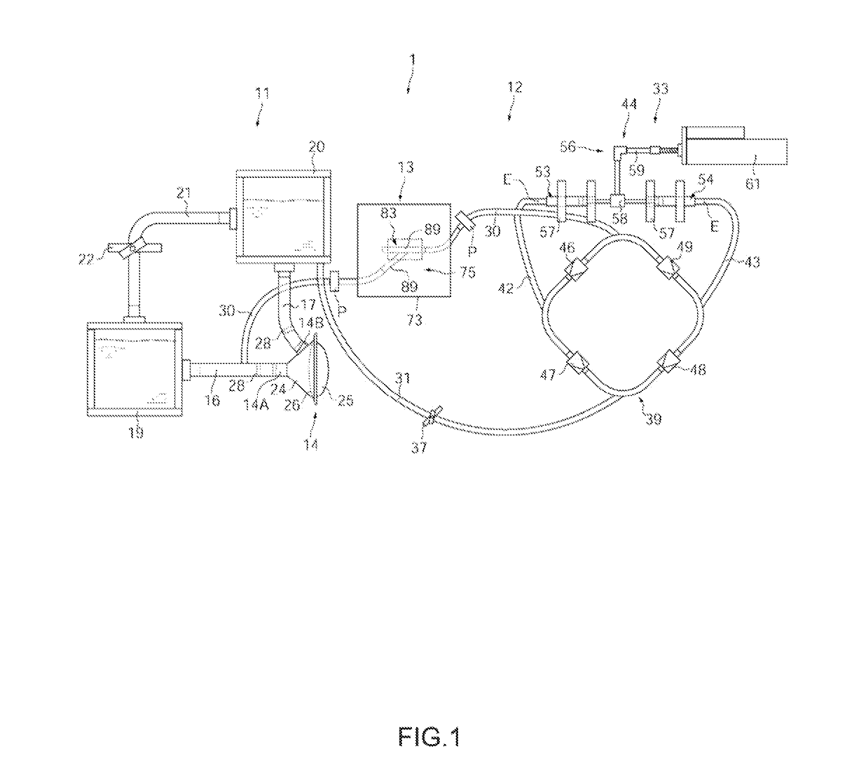

FIG. 1 shows a schematic configuration view of a system for evaluating training for coronary artery bypass surgery in accordance with the embodiment of the present invention. In the figure, the system 1 for evaluating training comprises conducting coronary artery bypass surgery under pulsation using a simulated blood vessel as a training blood vessel and passing a fluid with a flow pattern simulating the human coronary artery flow through the post-training simulated blood vessel, said system enabling an evaluation of the training results from the conditions in which said fluid passes therethrough.

The system for evaluating training 1 is a circuit configuration in which said fluid can be circulated, wherein said system comprises: a pulsating flow generating unit 11 that provides pulsation to said fluid; a coronary artery flow generating unit 12 which is branched from the pulsating flow generating unit 11 and which converts the flow state of the pulsating flow into a coronary artery flow upstream; and a surgery training unit 13 that is located upstream from the coronary artery flow generating unit 12 and that operates to enable training in bypass surgery of coronary arteries under pulsation. In addition, the fluid applied to the present system is not particularly limited and may be exemplified by liquids such as blood, a liquid simulating blood or the like, physiological saline, water, designated treatment solutions, and the like.

Said pulsating flow generating unit 11 has a circuit configuration in which said fluid can be circulated to simulate the systemic circulation, and comprises a pulsation pump 14 for causing the fluid to pulsate in simulation of the pulsation of the blood from the heart; an aorta tube 16 connected to an outflow part 14A of the pulsation pump 14, in simulation of the human aorta; a great vein tube 17 connected to the inflow part 14B of the pulsation pump 14, in simulation of the human great vein; a first tank 19 connected to the aorta tube 16; a second tank 20 connected to the great vein tube 17; a peripheral tube 21 to allow the first tank 19 to communicate with the second tank 20; and a resistor device 22 that is located in the midway of the peripheral tube 21to provide a resistance to the fluid in said peripheral tube 21.

Said pulsation pump 14 has a diaphragm 26 which partitions a main space 24 that holds said fluid and a subspace 25 that holds air. The diaphragm 26 is set up such that it undergoes a displacement by pneumatic pressure exerted to the subspace 25, with said displacement varying the volume of the main space 24, thereby enabling the fluid to be discharged to, and sucked from, the main space 24. In addition, the pressure of the fluid pumped out by the pulsation pump 14 can be varied by adjusting the pneumatic pressure displacing the diaphragm 26 and by said resistor device 22. The fluid pumped out by the pulsation pump becomes a pulsating flow corresponding to the aortic flow from the human heart.

In addition, said pulsation pump is not limited to one with the structure as described above, and may be any structure capable of imparting a pulsating flow to the fluid as in the heart.

Said first tank, which is filled with said fluid and air therein, is provided to simulate the attenuation state that the blood stream undergoes due to blood vessel elasticity when the blood stream passes through the aorta. In other words the liquid volume and pneumatic pressure within the first tank 19 are adjusted so as to correspond to the flow behavior after the fluid flowing through the peripheral tube passes the aorta.

Said second tank 20, which is filled with said fluid and air therein, is provided to simulate the bloodstream state after the bloodstream passes through the vein. In other words the liquid volume and pneumatic pressure within the tank 20 are adjusted such that the fluid flowing through the great vein tube 17 will assume the state of the flow immediately after having converged on the great vein from various veins in the body.

Said resistor device 22, although not particularly limited, is a pinchcock-like device, capable of compressing the peripheral tube 21 from its exterior circumferential side, thereby simulating peripheral resistance.

Such pulsating flow generating unit 11 constitutes a circuit where the fluid pumped out of pulsation pump 14 passes through the aorta tube 16, peripheral tube 21, great vein tube 17, and back to the pulsation pump 14. Further, check valves 28 are mounted in the aorta tube 16 and great vein tube 17, thereby maintaining said unidirectional circulation state and preventing a back flow of the fluid during operation of the pulsation pump 14.

Said coronary artery flow generating unit 12 constitutes a circuit simulating the coronary circulation around the myocardium, allowing said fluid to be circulated therethrough, and operates so as to convert the pulsating flow into coronary artery flow by having suction force imparted to the pulsating flow generated in the pulsating flow generating unit 11. The coronary artery flow generating unit 12 comprises an inlet side flow path 30 branched from said aorta tube 16, an exit side flow path 31 made up of a tube connected to said second tank 20, and a coronary circulation simulator 33 located between these flow paths 30 and 31, which causes the flow state in the inlet side flow path 30 to simulate that of the human coronary artery.

In the midway of said inlet side flow path 30 are provided the surgery training unit 13 and pressure gauges P disposed in the upstream and downstream sides of the surgery training unit 13 (However, if the pressure at either side is known (such as in case of the atmospheric pressure), either one of the abovementioned pressure gauges may suffice). The surgery training unit 13 allows trainees such as physicians and medical students to be trained in the following coronary artery bypass surgery under a real life-like pulsation. The training calls for performing anastomosis of an end part of a new simulated blood vessel 89′ to the midsection of an initially present simulated blood vessel 89, thereby generating a Y-shaped flow path from these simulated blood vessels 89 and 89′. The one end part of the initially present simulated blood vessel 89 and the other unanastomosed end are joined in the midway of the inlet side flow path 30, with the other end of the initially present simulated blood vessel 89 being in a blocked state. This arrangement allows the anastomosed simulated blood vessels 89 and 89′ to pass a fluid imparted with a coronary artery flow, thereby consequently enabling various evaluations of the anastomosed sites through bypass surgery consistently with actual post-surgery conditions.

In the midway of the exit side flow path is mounted a pressure adjustment means 37 for adjusting the pressure of the fluid flowing in the coronary artery flow generating unit 12. Although not particularly limited, the pressure adjustment means 37 is equipped with a pinchcock-like resistor device whereby varying the inside diameter of the exit side flow path 31 provides a resistance to the fluid flowing through said flow path 31.

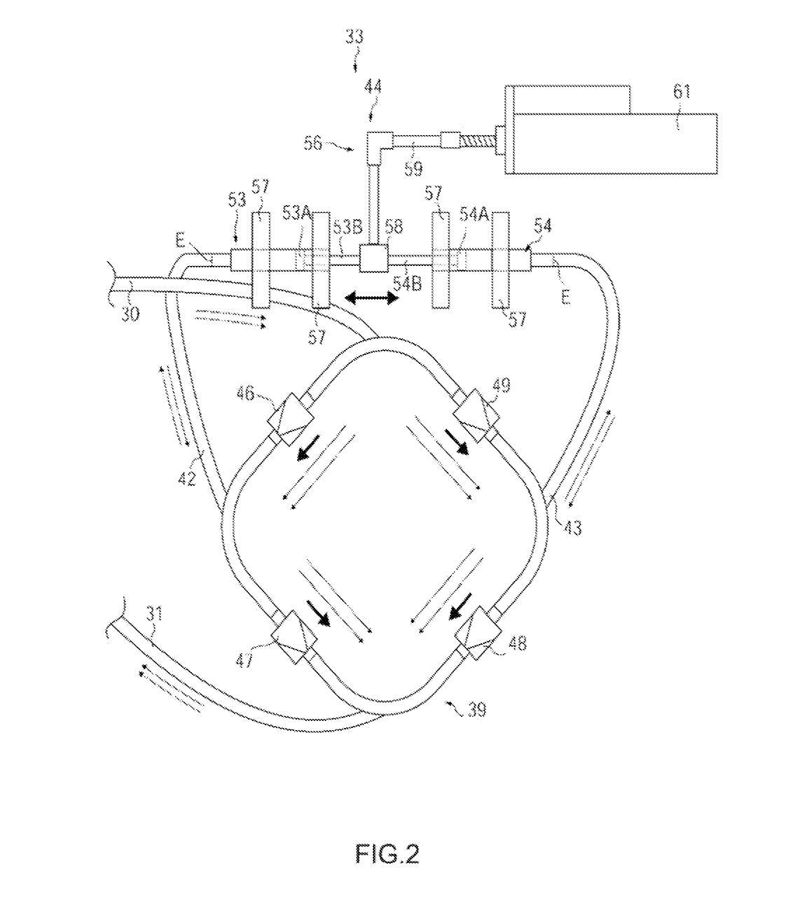

The coronary circulation simulator 33, as also illustrated in FIG. 2, comprises a loop flow path 39 made up of closed loop-shaped tubes connected respectively to the inlet side flow path 30 and exit side flow path 31, first and second branched flow paths 42 and 43 made up of tubes branched respectively from the loop flow path 39, and an actuator 44 mounted between the end parts of the these branched flow paths 42 and 43.

To the loop flow path 39 are connected at nearly evenly spaced apart positions, the inlet side flow path 30, exit side flow path 31, and the first and second branched flow paths 42 and 43. Specifically, the inlet side flow path 30 and exit side flow path 31 are connected nearly 180 degrees apart, at top and bottom positions in FIG. 2. The first and second branched flow paths 42 and 43 are connected nearly 180 degrees apart, at the right and left positions in FIG. 2.

Further, at four sites in the midway of the loop flow path 39 are mounted, evenly spaced apart, first to fourth check valves 46 to 49; these check valves 46 to 49 are mounted respectively as directed to allow the flow in the arrowed directions indicated by solid lines in FIG. 2.

In other words, said first check valve 46 is mounted between the connection part of the inlet side flow path 30 and the connection part of the first branched flow path 42, so as to permit only a flow in a left downward direction in FIG. 2.

The second check valve 47 is mounted between the connection part of the first branched flow paths 42 and the connection part of the exit side flow path 31, so as to permit only a flow in a right downward direction as in FIG. 2.

The third check valve 48 is mounted between the connection part of the exit side flow path 31 and the connection part of the second branched flow path 43 to the right side in FIG. 2, so as to permit only a flow in a left downward direction as in FIG. 2.

The fourth check valve 49 is mounted between the connection part of the second branched flow path 43 and the connection part of the inlet side flow path 30, so as to permit only a flow in a right downward direction as in FIG. 2.

Said actuator 44 comprises first and second syringes 53 and 54 having outlet ports connected to the first and second branched flow paths 42 and 43, a driver unit 56 which simultaneously increases or decreases the volumes of these syringes 53 and 54 under opposite states thereof, and supports 57 that support the first and second syringes 53 and 54.

The first and second syringes 53 and 54 comprise piston plates 53A and 54A that partition the interior spaces holding a fluid and rods 53B and 54B that are connected to these piston plates 53A and 54A. These piston plates 53A and 54A are mounted in opposing directions aligned on a nearly straight line.

The driver 56 comprises a connector member 58 that connects integrally the opposing ends of the rods 53B and 54B, a coupling rod 59 connected to said connector member 58, and a motor 61 which is connected to the coupling rod 59 and which moves the connector member 58 in a designated direction. The driver 56, as driven by the motor 61, enables the rods 53B and 54B of each of the syringes 53 and 54 that are aligned on a straight line to simultaneously move along the same direction on said straight line. That is, as the motor 61 drives each of the syringes 53 and 54 which are aligned back to back in a right and left direction, the connector member 58 moves in the right and left direction, with which the volumes of the spaces in each syringes 53 and 54 end up increasing or decreasing in an opposing way. In other words, as the connector member 58 moves to the left in FIG. 2, the volume in the first syringe 53 on the left in the same figure decreases, thereby outputting the fluid in the first syringe 53 from the first branched flow path 42 into a loop flow path 39, and at the same time increasing the volume in the second syringe on the right in the same figure, thereby sucking the fluid from the loop flow path 39 into the second branched flow path 43. On the other hand, as the connector member 58 moves to the right in FIG. 2, an operation opposite to the foregoing occurs in that the fluid is outputted from the second branched flow path 43 into the loop flow path 39, at the same time causing the fluid to be sucked from the loop flow path 39 into the first branched flow path 42. Herein, the timing of the motor 61 is such that it is set up to operate at a timing nearly synchronous with said pulsation pump 14 (see FIG. 1). Specifically, the connector member 58 is set to move only in a single direction over a designated movable range during a single period of the pulsation pump 14 running through a systolic period and a diastolic period. Accordingly, in two periods of the pulsation pump 14, the connector member 58 is set to perform a single reciprocating movement over said movable range. Furthermore, the movable range can be arbitrarily varied, whereby the volumes of the liquid sucked into each of the syringes, 53 and 54, vary, making it possible to adjust the flow rate of the fluid flowing through the coronary artery flow generating unit 12.

Further, said motor 61 may be replaced by the use of various actuators such as cylinders that provide a similar function as described above.

Explained next is the procedure to generate a coronary artery flow by the pulsating flow generating unit 11 and coronary artery flow generating unit 12.

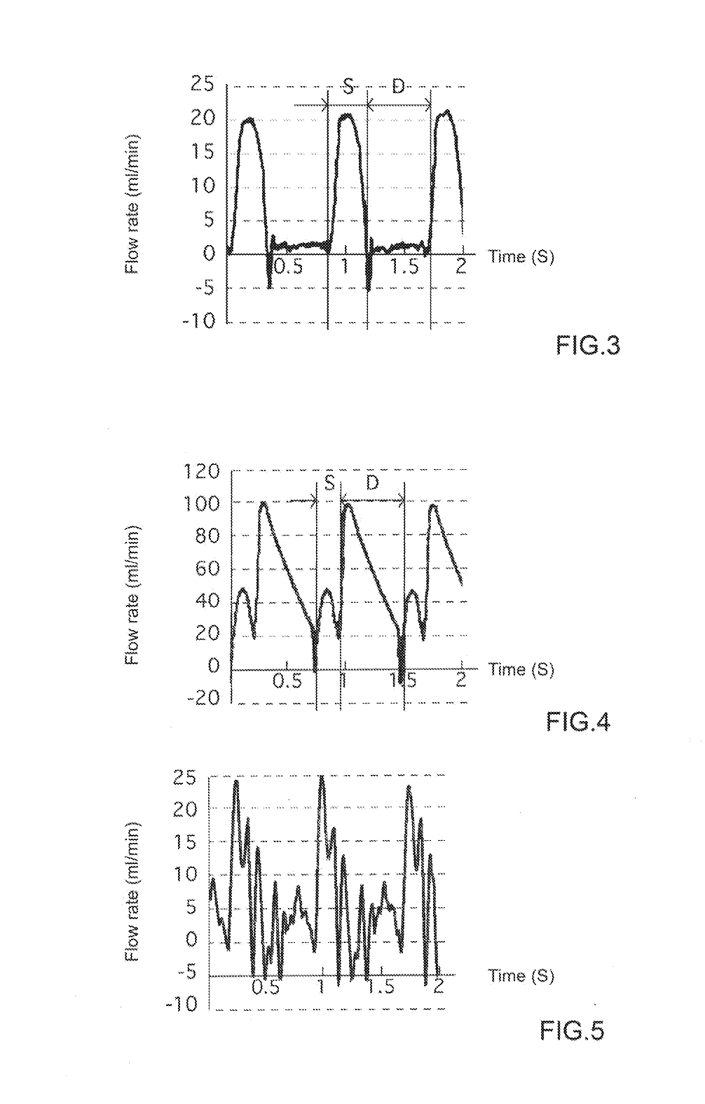

The pulsating flow generating unit 11 generates a fluid circulation state simulating the circulation state in the human body, by operation of the pulsation pump 14. There is obtained in the aorta tube 16 a flow rate wave pattern approximating the aorta flow in vivo, as shown in FIG. 3. Simultaneously therewith in the coronary artery flow generating unit 12, the motor 61 drives nearly synchronously with the pulsating flow from the pulsation pump 14; each of the syringes 53 and 54 function to cause the fluid from the aorta tube 16 to be sucked into the coronary artery flow generator 12 side.

The driving of the motor 61 will cause the connector member 58 to reciprocate in a right and left direction as in FIG. 2, where regardless of which way, right or left, the connector member 58 moves to, i.e., regardless of whichever way the volumes of each of the syringes 53 and 54 change, either increasing or decreasing, the use of suction force of either of the syringes 53 or 54 will cause the fluid of the pulsating flow generating unit 11 to flow from the inlet side flow path 30 into a coronary circulation simulator 33, and to flow out from the exit side flow path 31 to the pulsating flow generating unit 11. In other words, when the connector member 58 moves to the left in FIG. 2, the fluid is allowed to flow, in the coronary circulation simulator 33, through a route in an arrowed direction indicated by the one-dot chain line in the same figure, by which route the fluid from the inlet side flow path 30 will flow to the exit side flow path 31. On the other hand, when the connector member 58 moves to the right, the fluid is allowed to flow, in the coronary circulation simulator 33, through a route in an arrowed direction indicated by the two-dot chain line in the same figure, by which route the fluid from the inlet side flow path 30 will flow to the exit side flow path 31. As a result, the present inventors' experiments show that there are obtained flow rate wave patterns approximating those of the coronary artery flow in vivo, as shown in FIG. 4. That is, when the motor 61 is at a standstill while the fluid in the pulsating flow generating unit 11 is in the circulation state, there is, in the inlet side flow path, as shown in FIG. 5, a state of a flow rate wave pattern as if noise was added to that of FIG. 3. Namely, in this case, as being subjected to the pulsation of the pulsation pump 14, a small amount of fluid flows from the inlet side flow path 30 to the coronary artery flow generating unit 12 side, where a resistance or the like in the flow path in the coronary artery flow generator 12 degrades the flow rate wave pattern of the pulsating flow shown in FIG. 3 into the flow rate wave pattern of FIG. 5. However, as described above, when the motor 61 is driven so as to synchronize with the operation of the pulsation pump 14, fluid suction will occur continuously using either one of the syringes 53 or 54, during the time from the systolic period to the diastolic period of the pulsation pump 14. Thus, the suction force of the syringes 53 and 54 act, with a designated time delay, on the flow rate wave pattern of FIG. 3, making it possible to obtain a flow rate wave pattern approximating the coronary artery flow in the human body as shown in FIG. 4. In other words, the flow rate wave pattern of the fluid passing through simulated blood vessels 89 and 89 in the surgery training unit 13 has, as with the coronary artery flow in vivo, small crests corresponding to the systolic period S of the pulsating flow, large crests corresponding to the diastolic period D thereof, along with the formation of trough parts between these two crests characteristic of coronary artery flow.

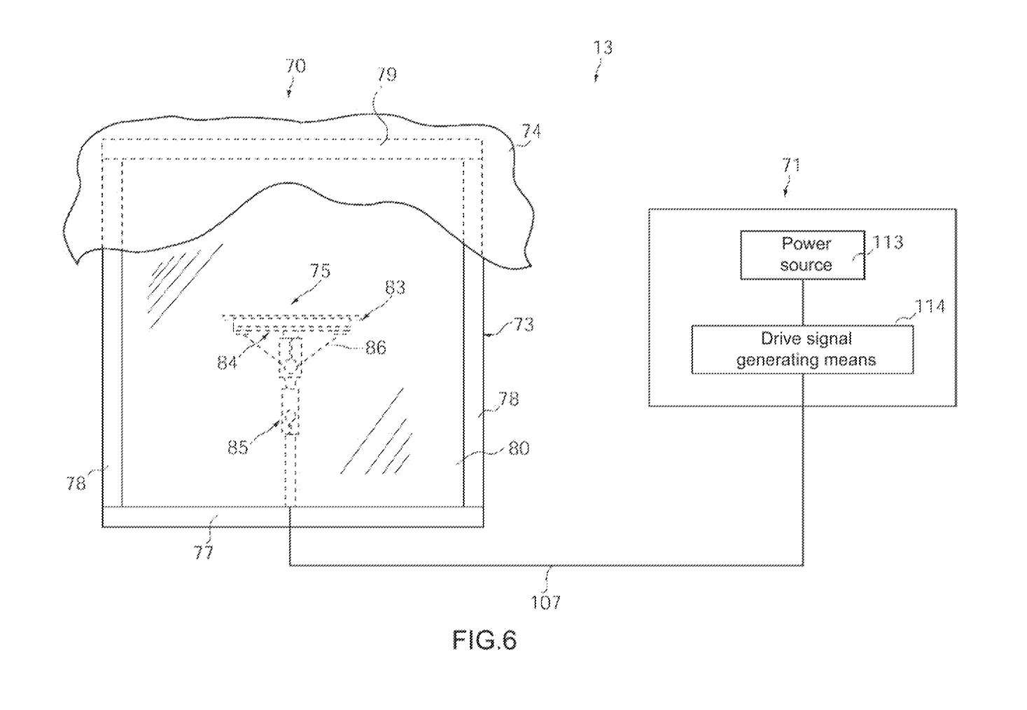

As illustrated in FIG. 6, said surgery training unit 13 comprises a training unit 70 and a control unit 71 which controls the operation of training sites in the training unit 70.

Said training unit 70 comprises a box-shaped case 73 with an open top, a sheet 74 covering a top of the case 73, and an object to be treated 75 arranged in the case 73 so as to correspond to the affected site.

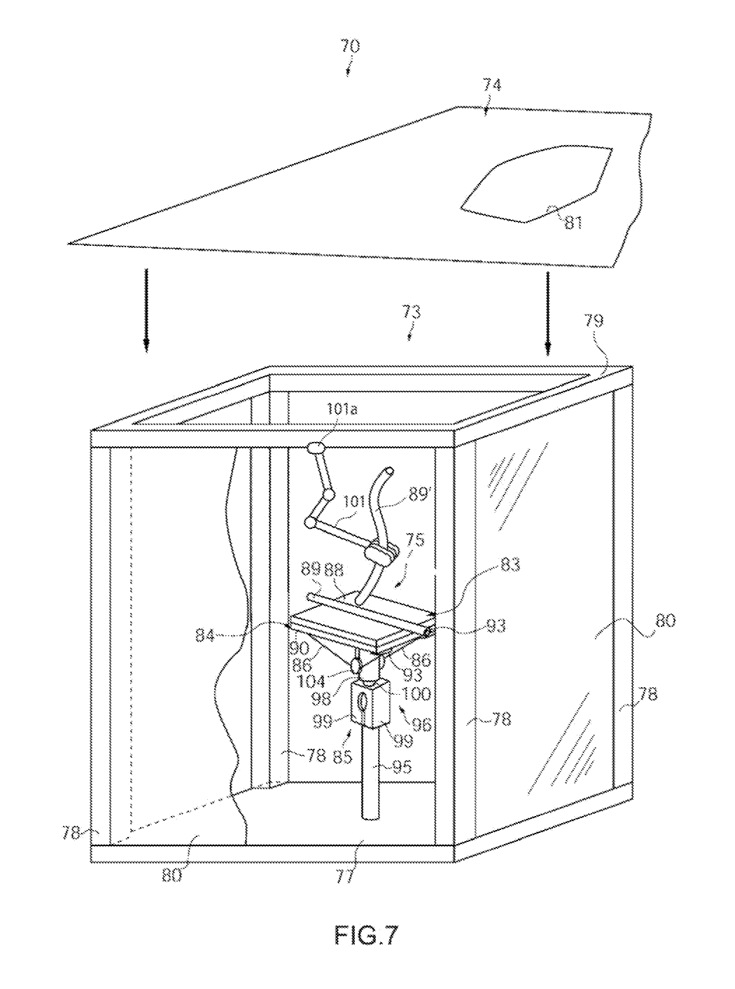

Said case 73 is built to make its interior space equivalent to the thoracic cavity. As illustrated in FIG. 7, the case 73 comprises a base 77 of a rough square in a planar view which base supports, from below, the object to be treated 75; nearly square-pillar shaped posts 78 which are disposed vertically at the four corners of the base 77; a frame 79 of a rough square shaped frame in a planar view which is connected between the top ends of these posts 78; and a side wall 80 made of transparent acrylic sheet, lateral to the case 73, disposed between each of the posts 78.

Said sheet 74, a member corresponding to the human skin part, is formed of latex or the like rubber of designated elasticity. The sheet 74 has, in an approximate center thereof, an incision opening 81 simulating an incision site on the skin such that when the sheet 74 is placed to cover the top of the case 73, the trainee can access, from the exterior top of the case 73, an object to be treated 75 therein, through the incision opening 81. Furthermore, the sheet 74 is arranged to be fastened to the frame 79 by means of a fastening device, not shown.

Said object to be treated 75 comprises a simulation body 83 as a training object to be subjected to a designated treatment during surgery training, a holder 84 for holding the simulation body 83 from below, a support 85 for supporting the holder 84 operably, and an electric wire 86 for connecting the holder 84 to the support 85.

Said simulation body 83, which is formed to simulate a part of a body tissue used as a training object, is formed of silicone and the like simulating part of the heart surface on which the coronary arteries are exposed, as illustrated in FIGS. 7 to 9 in the present embodiment. The simulation body 83 comprises a nearly rectangular parallelepiped-shaped simulated myocardium 88, a simulated blood vessel 89, as a training blood vessel, which is fixed nearly in the center in the shorter-width direction, on the upper face side of the simulated myocardium 88 and which extends in the lengthwise direction of the simulated myocardium 88. At the time of training in coronary artery bypass surgery in the present embodiment, a midway portion of the simulated blood vessel 89 is incised, where said incision site is subjected to a procedure for anastomosing one end side of another simulated blood vessel 89′ thereto. Said another simulated blood vessel 89′ is retained by a retention clip member 101 which is for positioning one end thereof opposite to the midway of said simulated blood vessel 89. The midway portion of said retention clip member 101 is formed to be flexible so as to allow positioning said simulated blood vessel 89′ in all directions and at the same time it has its base end part 101a fixated to the frame 79 of said case 73.

Said holder 84 comprises a holder plate 90 attached to the underface of side of the simulated myocardium 88, a nearly cylindrical center protrusion part 91 protruding downward from the center part of the underface of the holder plate 90, a coil spring 92 as a biasing means attached to the center protrusion part 91, and nearly cylindrical corner protruding parts 93 protruding downward from each of four corners of the underface of the holder plate 90.

Said holder plate 90 is a flat face shape roughly identical to the simulated myocardium 88, although not particularly limited, which plate not only makes it possible for the simulation body 83 to be removably attached thereto, but also for the simulation body 83 to be fastened relatively immovably once it is attached thereto.

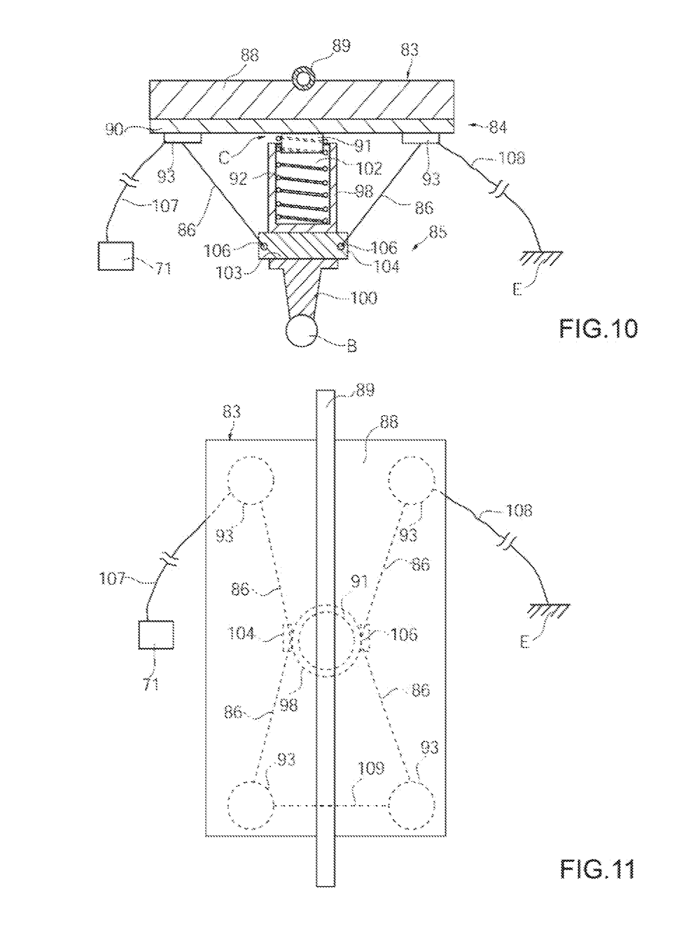

As shown in FIG. 10, said coil spring 92 has its top end portion wound fixed around the outer circumference of the center protrusion part 91 and is set to extend downward below the center protrusion part 91 at the initial state in FIG. 10, thereby biasing the holder plate 90 upward in FIG. 10. Although a coil spring 92 is used in the present embodiment, this may be replaced by other biasing means such as other springs, rubber, and the like, as long as the below-described operations can be performed.

Said wire 86 is attached to each corner protrusion part 93, and although not particularly limited, the height of each corner protruding part 93 is set lower than the center protrusion part 91.

As shown in FIGS. 7 to 9, said support 85 comprises a round bar shaped leg member 95 which is removably arranged vertically to the base 77 and a universal joint 96 which connects said holder 84 and the leg member 95.

Said universal joint 96 is set to render the posture of the simulation body 83 variable and to lock said simulation body 83 at the desired posture. Namely, the universal joint 96 comprises an upper side member 98 to which is attached said holder 84, a lower side member 99 to which is attached the leg member 95, and an intermediate member 100 which is linked to the lower end side of the upper side member 98 and which connects the upper side member 98 to the lower side member 99 so as to be multidirectionally rotatable in a nearly full circle.

As shown in FIG. 10, said upper side member is formed as a bottomed cylinder with an open top end, and comprises a receptor part 102 which accommodates said coil spring 92, a through-hole 103 penetrating in a radial direction at a location beneath the receptor part 102, and a shaft member 104 which is inserted through the through-hole 103.

Said receptor part 102 has mounted, on the bottom thereof, the lower end part of the coil spring 92 and is set up at such a depth at the initial state in FIG. 10 when the device is not in operation that the upper part of the coil spring 92 can protrude out to the outside. Therefore, there is generated at said initial state a clearance C between the underface of the holder plate 90 and the top end of the upper side member 98.

Said shaft member is set larger than the external diameter of the upper side member 98 and is placed and fixed such that both end sides in an extending direction (both right and left end sides in FIG. 10) protrude outside of the upper side member 98. These protruding parts are provided with small holes 106 piercing through the shaft member 104. As will be described later, the small holes 106 are set to allow said wire 86 to be inserted therethrough.

As shown in FIGS. 7 to 9, said lower side member 99 is built to allow inserting, from its lower end side, the upper part of the leg member 95 thereinto; and the lower side member 99 is set to be fastened to the leg member 95 by tightening a screw S (See FIG. 9). Herein, a selective use of a different length leg member 95 permits the overall height of the support 85 to be varied. In other words, a selection of the leg member 95 can change the distance from the top end of the case 73 (see FIG. 7) to the simulation body 83.

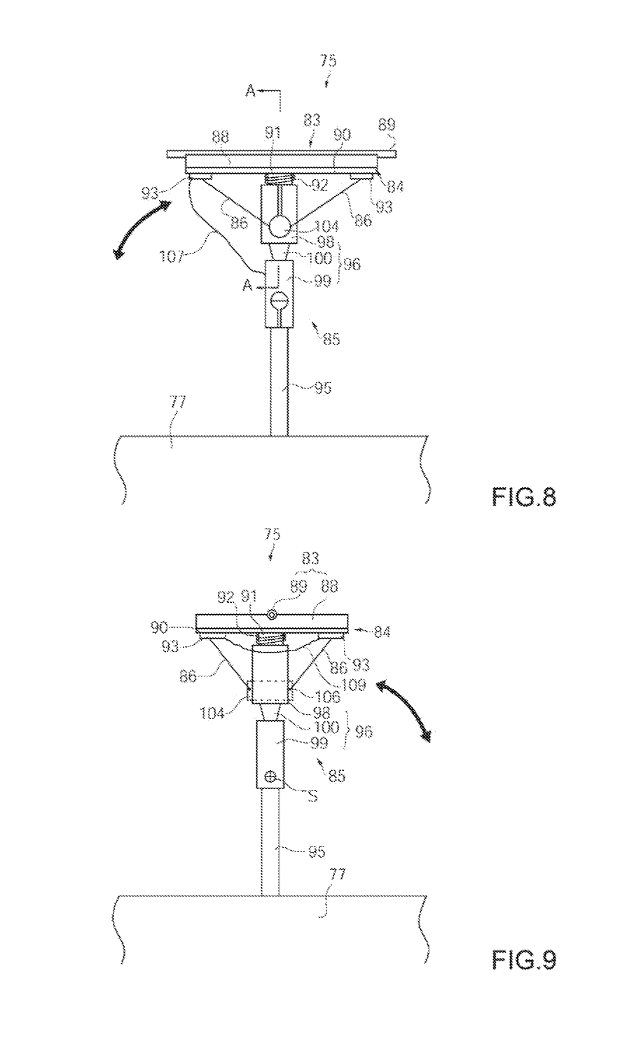

Said intermediate member 100 is built to enable the upper side member 98 to rotate relative to the lower side member 99, around a spherical member B (See FIG. 10) at a lower end thereof as a center of rotation, in the arrow directions in FIGS. 8 and 9. Tightening a screw (not shown) mounted at an outer circumference side of the upper side member 98 makes it possible to lock the angle of upper side member 98 relative to the lower side member 99 at the desired value. Since the upper side member 98 is linked to the simulation body 83 and holder 84 via a coil spring 92, the posture of the simulation body 83 can vary with a change in the posture of the upper side member 98, thereby permitting training at a different angle of the simulation body 83 with respect to the support 85 in accordance with the training object. For example, for anastomotic training of coronary arteries on the front part of the heart, the face of simulation body 83 is set in a nearly horizontal direction, while for anastomotic training of the coronary arteries on the lateral part of the heart; the face of the simulation body 83 is set in an inclined direction. Although it is not particularly limited, the distance from the simulated blood vessel 89 of the simulation body 83 to the center of rotation of the intermediate member 100, i.e., the spherical member B, is set at 40 mm to 45 mm.

Said wire 86 is formed of a shape memory alloy, which becomes shrinkable due to the heat generated when an electric current flows, such as a Ti—Ni type, Ti—Ni—Cu type or the like system, as disclosed, for example, in Japanese Unexamined Patent Application Publication Nos. 2005-193583 and S57[1982]-141704 and the like. As illustrated in FIG. 11, two wires 86 are made available, one of which is inserted from an upper left corner protruding part 93 in the figure through the small hole 106 of the shaft member 104 reaching a lower left corner protruding part 93 in the figure, while the remaining wire is inserted from an upper right corner protruding part 93 in the figure through the small hole 106 of the shaft member 104, reaching a lower right corner protruding part 93 in the figure. To the end of the wire 86 attached to the upper left corner protruding part 93 in FIG. 11 is connected an entry side electric wire 107 through which flows an electric current controlled by a control unit 71. Also to the end of the wire 86 attached to the upper right corner protruding part 93 in FIG. 11 is connected an exit side electric wire 108 connected to ground wire E. Moreover, a connecting electric wire 109 is connected between the ends of the wires 86 and 86 attached to each of the lower left and lower right corner protruding parts 93 and 93 in FIG. 11. Therefore, the two wires 86 and 86 end up being electrically connected in series, and the electric current from the control unit 71 side will flow from the wire 86 located in the left in FIG. 11 to the ground E via the electric wire 86 placed in the right. At said initial state, these wires 86 and 86 are stretched to each of the corner protruding parts 93 under a state of a designated tension imparted thereto. Further, although not particularly limited, the entry side electric wire 107 and exit side electric wire 108, which are partially exhibited in FIGS. 6 and 8, are set to run through the interior space of the support 85 from the case 77 to the outside of the case 73.

The wire 86 may be replaced by connecting means of other shape such as a thin sheet form or the like as long as an effect similar to that described above is obtained, without being particular about the quality of the material and the like, provided that it is made of a shape memory material that can contract when an electric current flows therethrough.

As shown in FIG. 6, said control unit 71 comprises a power source 113 and a drive signal generating means 114 that supplies an electric current from the power source 113 to the wire 86 at a designated timing. The drive signal generating means 114 varies the supply state of the electric current to the wire 86 and repeats contraction of the wire 86 and restoration thereof to its original shape, thereby controlling the operation of the simulation body 83 which is integrated with the holder 84. Specifically, the control unit 71 comprises an instrument capable of providing the wire 86 with a supply voltage of a preset designated wave pattern, and is comprised of an instrument commonly known in the art such as signal generators like function generators, etc. and amplifiers, etc. In addition the drive signal generating means 114 is enabled to control the duty ratio and/or the output wave pattern of the supply voltage to the desired states. Although not particularly limited, the present embodiment uses, as an output wave pattern, a pulse wave (square wave) with a frequency set at a value from 0.5 Hz to 2 Hz and with the duty ratio set at about 10%. In addition, a computer may be used in place of the signal generator and amplifier; and not only a pulse wave but also other wave patterns such as a sinusoidal wave may be used as an output wave pattern.

With reference to FIGS. 6 to 10, the operation of said surgery training unit 13 is explained below.

First, for preparation before training, select a leg member 95 of the desired length in accordance with the training object site; attach said leg member 95 to the base 77 and the lower side member 99. Then, in accordance with the training object site, rotate the upper side member 98 multidirectionally relative to the lower side member 99, lock the upper side member 98 at the desired angle, thereby bringing the simulation body 83 into the desired posture. Then, upon turning on a switch, not shown, an electric current will be supplied in an ON-OFF manner at the desired timing from the control unit 71 to the wire 86. In this case, when the electric current is supplied, the wire 86 contracts due to the characteristics of said wire 86, thereby developing a downward tensile force against the holder plate 90 that is integrated with the corner protruding part 93 to which is attached said wire 86. Then, with the compression of the coil spring 92 attached to the center protrusion part 91 of the holder plate 90, the holder plate 90 and simulation body 83 will shift downward from said initial position. On the other hand, when the electric current supply is cut off, the wire 86 having shape in memory will extend so as to be restored to the original length; and the holder plate 90 and simulation body 83 will shift upward with the restoring force of coil spring 92, thereby returning to said initial positions. That is, application of the supply voltage, which will generate a pulse wave pattern, from the control unit 71 will bring the simulation body 83 and holder 84 away from, or close to, the support 85, thereby moving them up and down within the range of the clearance C (See FIG. 10). Setting this state as that of heart pulsation, the trainee puts his hand through an incision opening 81 of the sheet 74 and treats the simulated blood vessel 89 with anastomosis of another simulated blood vessel 89′ thereto, along with an up-and-down motion of the simulation body 83, whereby training in various treatments related to coronary artery bypass surgery is provided.

Herein, the pulsating state of the simulation body 83 can be changed by varying the magnitude of the supply voltage and/or duty ratio using the control unit 71. For example, lowering the supply voltage reduces the heating of the wire 86, in turn, reducing the amount of contraction (strain), and enabling a smaller-amplitude pulsation state to be produced. Lowering the duty ratio increases the OFF time for the electric current supply and can produce a slower-motion pulsation state.

Thus, as shown in FIG. 1, the simulated blood vessels 89 and 89′ anastomosed on the simulation body 83 that operates similarly to the actual heart pulsation state will be connected to the midway of the inlet side flow path 30. When the coronary artery flow fluid generated by said pulsating flow generating unit 11 and coronary artery flow generating unit 12 passes the inlet side flow path 30, it will pass through the anastomosed simulated blood vessels 89 and 89′. Herein, use of the pressure gauges P mounted onto the upstream and downstream sides of the simulated blood vessels 89 and 89′ for determining the respective pressures thereof makes it possible to determine whether or not the pressure loss from the upstream to downstream is equal to or lower than a threshold value that induces thrombus formation. If said pressure loss is equal to or greater than said threshold value, the conditions of the simulated blood vessels 89 and 89′ will be rated poor. In addition, although not illustrated, the conditions of the anastomosed simulated blood vessels 89 and 89′ can be assessed by mixing in fluorescent particles in the fluid, applying a laser light to said fluorescent particles, thereby visualizing the flows in the simulated blood vessel 89 and 89′ and in their downstream sides and observing the flow condition, which is an occurrence factor for thrombus formation.

Furthermore, if the upstream side pressure is known, such as when open to the atmosphere pressure, it is permissible to measure the above-mentioned pressure loss with the downstream pressure gauge P alone. In that case the value measured with the downstream pressure gauge P (which is the difference relative to the atmospheric pressure) is the pressure loss, which is evaluated whether or not it is equal to or lower than the threshold value.

Therefore, such an embodiment makes it possible to train in bypass surgery of coronary arteries under pulsation and to evaluate the results of said training using a flow corresponding to actual coronary artery flow, whereby effects are obtained that permit simultaneous training under pulsation close to actual conditions and an accurate evaluation of the post training sites.

Furthermore, adjusting the movement position and the magnitude of the movement of the connector member 58 can vary the output rates of the fluid from syringes 53 and 54, thereby making it possible to control the rate of flow circulating in the coronary artery flow generating unit 12. Control of the flow rate in the coronary artery flow generating unit 12 with such a configuration can be executed independently of the fluid pressure control adjusted by the pressure adjustment means 37, thereby also offering the effect of being able to reproduce in the circuit the pathological conditions of individual patients such as high blood pressure-low blood flow rates and low blood pressure-high blood flow rates.

Further, in order to simplify the explanation of the surgery training unit 13 in said embodiment, use was made of a configuration that can realize a simplest one-degree-of-freedom operation (up-and-down motion) without being limited to this embodiment. Namely, the present invention can also use a surgery training unit 13 which permits the simulation body 83 and the holder 84 to undergo a variety of motions, such as linear, rotary, and/or torsional movements, by using many more wires, adjusting the locations at which these wires 86 are attached to the holder plate 90, and further by making the power source independently controllable, thereby allowing each wire 86 to independently contract and restore.

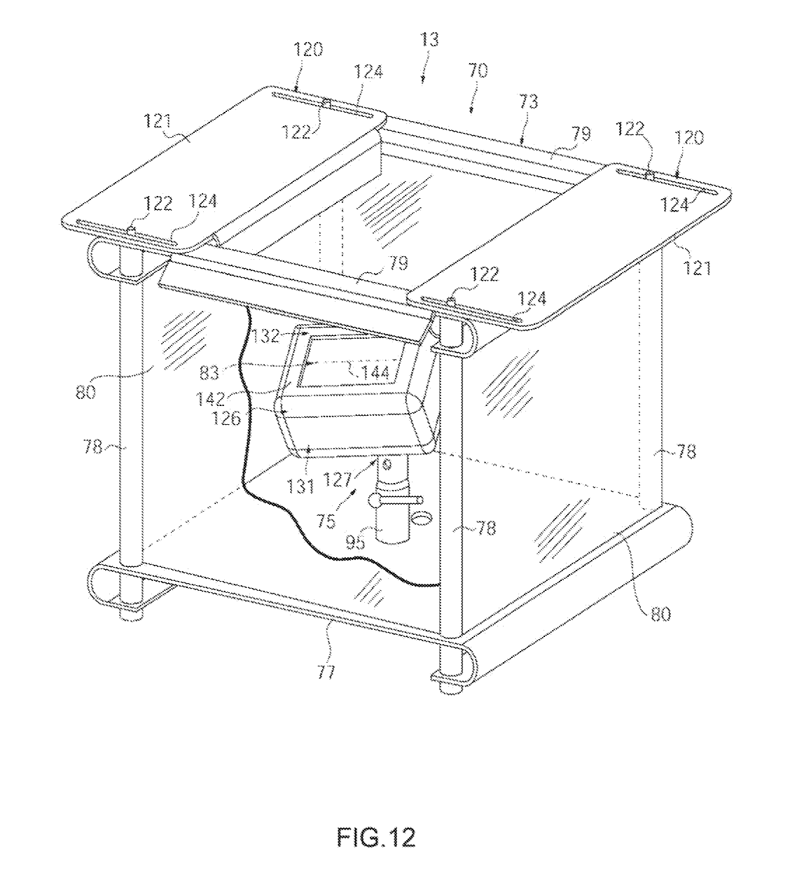

For example, as shown in FIG. 12, there is, for a modified example of said surgery training unit, a surgery training unit 13 in which the simulation body 83 can be moved independently in orthogonal triaxial directions. In a further explanation of the following modified examples for a surgery training unit 13, the same symbols will be used for configurational components identical to or equivalent to those of said surgery training unit 13 and explanations therefor will be omitted or simplified, except that only the configurational elements and functions different from those of said embodiment will be explained.

In a surgery training unit 13 related to the present modified example, there is provided on the upper part of said case 73, without having the sheet 74 (see FIG. 6, etc.) covering it, an operative field area adjustment mechanism 120 capable of adjusting the upper open area of the case 73. The operative field area adjustment mechanism 120, so as to vary said opening area that is envisioned to be an operative field area, comprises cover plates 121 and 121 and pins 122 that protrude upward at the four corners of said frame 79 which frame is arranged on the top of the case 73 and that supports the cover plates 121.

Said cover plate 121, although not particularly limited, is formed roughly in a rectangular shape and has a width in a front-back direction about equal to that of the frame 79 in that same direction, but it has a width in a right-left direction about half that of the frame 79 in the same direction. Each cover plate 121 has at both front and back ends thereof slot holes 124 for pins 122 to be passed through, such that each cover plate can be slid along the extended direction (right and left direction) of the slot 124, making each of the cover plates 121, 121 freely slidable in a right and left direction, bringing them apart or together. Since the field of vision within the case 73 from the opening part formed between the cover plates 121, 121 corresponds to the operative field, adjusting the open width of each cover plates allows arbitrarily varying an envisioned field-of-vision area, enabling one to freely set up the restraint conditions under which surgery instruments such as needle holders and forceps are used.

In addition, it is also possible, although not illustrated, to attach to a part or the entirety of the side wall 80, a balloon body, which can be inflated or deflated depending on the interior fluid volume. The balloon body is mounted in simulation to organs located around the heart, such as the diaphragm, the lungs, and the like in the thoracic cavity, and is formed, although not particularly limited, of elastic materials such as polyurethanes, silicone resins, and the like. Into the inside of said balloon body, a gas or liquid is fed and exhausted with respect to the outside of the case 73, where controlling these gas pressures or liquid pressures causes the behaviors of said organs to be simulated. Namely, since the diaphragm and/or the lungs undergo repetitious actions within a designated range in accordance with breathing, simulating such actions can provide trainees with a visual sense of presence close to an actual surgery situation. In other words, this allows simulating the visual sense of presence by the balloon body due to a relative motion between the pulsation behavior of the coronary arteries by the simulation body 83 and the behavior of the organs in the abdominal cavity. Use of a red color liquid simulating blood as a fluid fed into the balloon body can provide the trainees with a visual sense of presence due to a bleeding in the coronary arteries and in the interior of the thoracic cavity.

In addition, the post 78 related to the present modified embodiment, although not particularly limited, is a round bar shaped and detachable relative to the case 77 and frame 79, permitting the case 73 overall to be compacted for transporting the surgery training unit 13 and the like.

The object to be treated 75 related to the modification embodiment comprises said simulation body 83; a drive unit 126 that enables moving said simulation body 83 independently in an orthogonal triaxial (X-axis, Y-axis, Z-axis) direction; a universal joint 96 that is fastened to the lower end side of the drive unit 126, that makes the posture of the simulation body 83 variable, and that locks the simulation body 83 at the desired posture; and said leg member 95 to which is attached the universal joint 96.

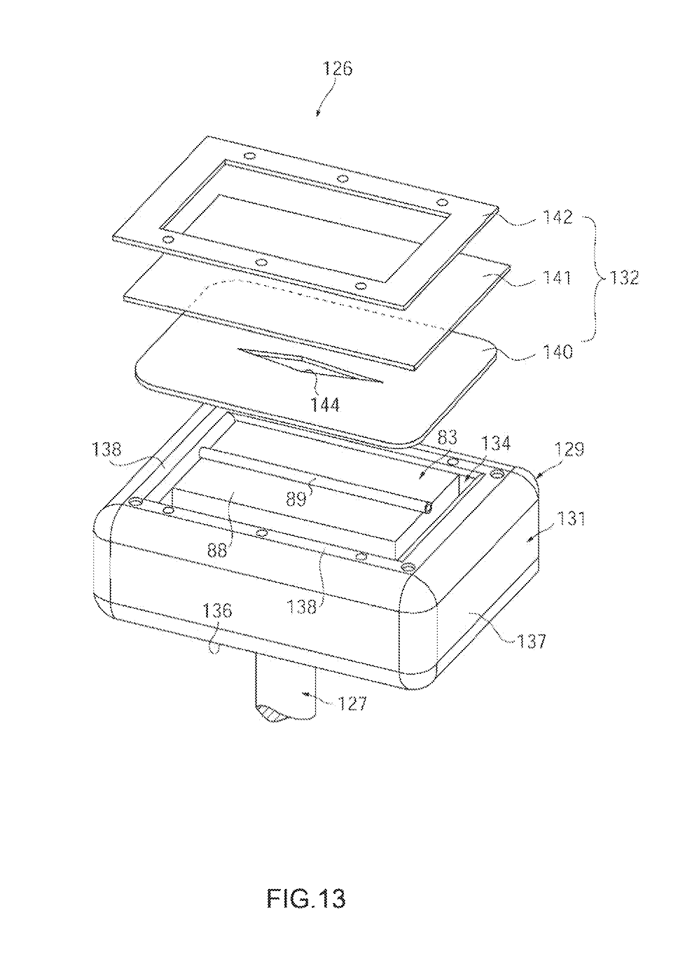

As shown in FIG. 13 to FIG. 15, said drive unit 126 comprises a box shaped holder 129 which has an internal space with its upper side being an open part; a cover unit 132 which covers the open portion of this holder 129 from up above; and a drive mechanism 134 which is mounted within the holder 129 and which supports the simulation body 83 movably in orthogonal triaxial directions.

Said holder 129 comprises a bottom wall part 136 which is nearly rectangular in a planar view, a side wall part 137 standing vertically along the periphery of the bottom wall part, and a collar 138 bent inwardly from the upper end side of the sidewall part 137. The interior space surrounded by these bottom wall parts 136, side wall parts 137, and collar parts 138 accommodate therein the simulation body 83 and drive mechanism 134, and is accessible from the open part, inside of the collar part 138.

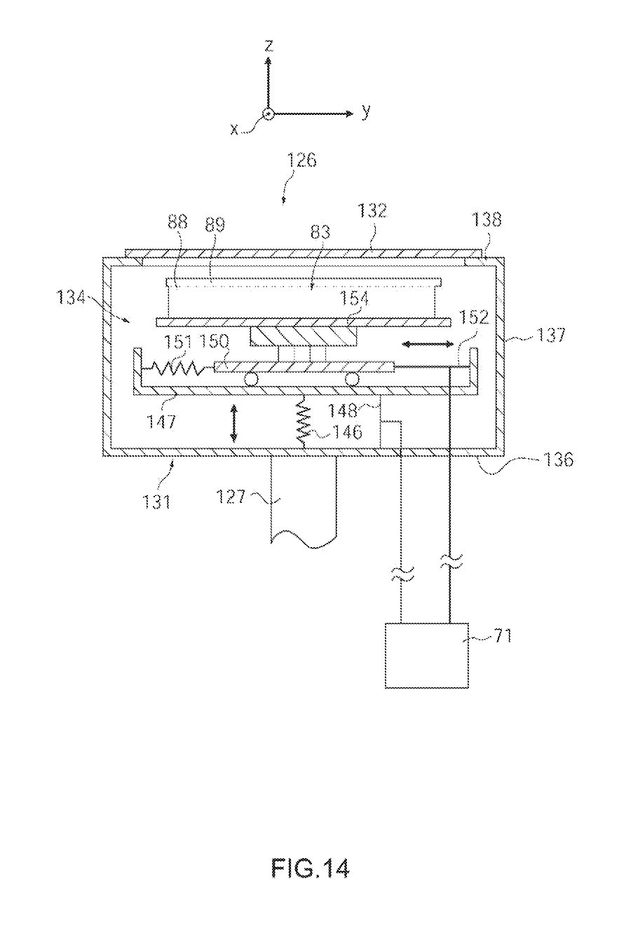

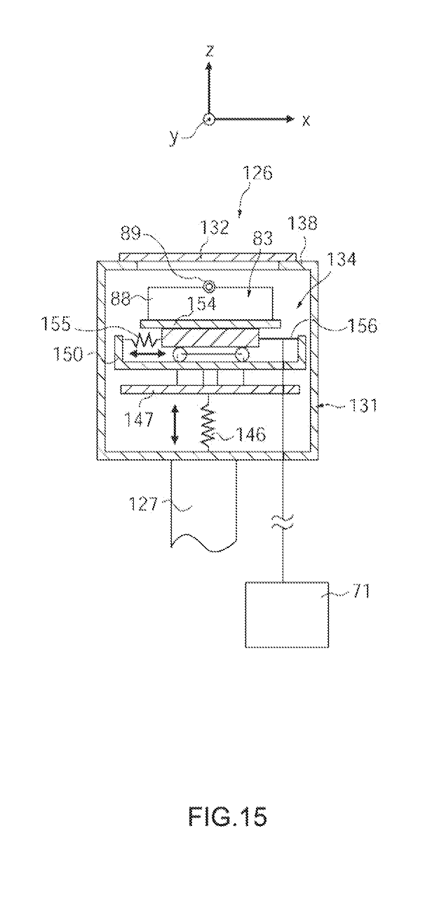

As shown in FIG. 14 and FIG. 15, said cover unit 132 is designed to close and cover said open part, with a space from the simulation body 83 and is arranged detachably from the holder 129. That is, the cover unit 132 comprises, as shown in FIG. 13, a resin-made simulated fat sheet 140 (fat layer) which simulates the fat covering the coronary arteries of the heart; a resin-made simulated pericardium sheet 141 (pericardium layer) which is overlaid on the top face of the simulated fat sheet 140 and which simulates the pericardium; and a metal-made clamping plate 142 which clamps down, sandwiching each of the sheets 140 and 141.

Said simulated fat sheet 140 is provided with a flat area slightly larger than said open part, and as attached to the holder 129, it has an incision 144 formed therein extending in a direction along said simulated blood vessel 89 so as to make the simulated blood vessel 89 therebelow accessible.

Said simulated pericardium sheet 141, although not particularly limited, is formed in a flat face shape about identical to the simulated fat sheet 140.

Said clamping plate 142 is enabled to cover each of the sheets 140 and 141 from the open part so as to make them unable to slip out by virtue of having a rectangular frame with its outer circumferential dimension about equal to that of the simulated pericardium sheet 141 and having each of the sheets 140 and 141 sandwiched and screwed shut between it and the collar 138 of the holder 129.

As conceptually illustrated in FIG. 14 and FIG. 15, said drive mechanism 134 is supported by a Z-axis spring 146 linked to a bottom wall part 136, and the mechanism comprises a Z-axis stage 147 which is movable in an up and down direction in these figures (the Z-axis direction); a Z-axis wire 148 held between the bottom wall part side 136 and the Z-axis stage 147, and a Y-axis stage 150 supported by the Z-axis stage 147 movably in a right-and-left direction (Y-axis direction) in FIG. 14, relative to the Z-axis stage 147; a Y-axis spring 151 and a Y-axis wire 152 installed between the Y-axis stage 150 and the Y-axis stage 150; an X-axis stage 154 which accommodates the simulation body 83 thereon and which stage is supported by the Y-axis stage 150 movably in an orthogonal direction (X-axis direction) to the paper in FIG. 14 relative to the Z-axis stage 147; and an X-axis spring 155 and an X-axis wire 156 installed between the Y-axis stage 150 and X-axis stage 154.

Accordingly, each of the stages 147, 150 and 154 constitute an operating mechanism to enable the simulation body 83 to make a relative movement to the holder 131; and each of the wires 148, 152, and 156 constitutes a connecting member connected between the holder 131 and each of the stages 147, 150, and 154.

Said wires 148, 152, and 156 are each formed of a shape memory alloy, the same as the above-described embodiment, which can contract when an electric current is passed. These wires 148, 152, and 156 are set so that electric current from said control unit 71 is supplied respectively as independently controlled thereto, where each of the wires 148, 152, and 156 is arranged such that contraction of each of the wires 148, 152, and 156 upon electric current supply causes each of the stages 147, 150, and 154 to move in their respective directions from their designated initial positions.

Said springs 146, 151, and 155 are each arranged so as to function as a biasing means in a direction opposite to the direction each of the stages 147, 150 and 154 connected to each of said wires 148, 152, and 156 moves when electric current is supplied to each of the wires 148, 152 and 156. Namely, each of the springs 146, 151, and 155 provide a biasing in directions to stretch each of the wires 148, 152, and 156 such that when electric current supply is stopped toward them, the corresponding stages 147, 150, and 154 can be smoothly restored to their initial positions. Furthermore, the present modification embodiment also permits employing other biasing means replacing each of the springs 146, 151, and 155 as long as they function similarly.

The surgery training unit 13 related to the foregoing modified example, as in the above-described embodiment of the surgery training unit 13, permits, upon repetitiously turning ON/OFF the electric current supplied to each of the wires 148, 152, and 156, independently and repeatedly moving and restoring each of the stages 147, 150, and 154. Thus the simulation body 83 can be made to pulsate in orthogonal triaxial directions; and moreover a numerous number of patterned pulsation states can be arbitrarily created by independently controlling the electric current supplied to each of the wires 148, 152, and 156, thereby making it possible to set up restraint conditions during surgery more closely to reality.

In addition, providing a cover unit 132 enables simulating tissues in the vicinity of the coronary arteries, such as fat, the pericardium, connective tissue, and the like, thereby making it possible to perform surgery training under a state closer to reality. In other words, since the coronary arteries pulsate below the fat layer and pericardial layer, this substantially restricts the operative field as seen from the incision 144, which is a simulated incision opening, raising the difficulty level of the operative procedures, thereby making it possible to carry out effective nearly clinical training.

Said cover unit 132 allows independently designing the fat layer and pericardium layer, resulting in the efficient development of devices that include them.

In addition, since the heart surfaces greatly differ among patients, it is feasible to prepare beforehand simulated fat sheets 140 and simulated pericardium sheets 141 of different properties and choose each of the sheets 140 and 141 matching the fat and pericardium needed for the training, thereby making it possible to reproduce a variety of operative field environments and respond to various trainees' needs.

In addition, the X-axis stage 154 and the like, on which is placed a simulation body 83, may be provided with a tactile sensor and/or pressure-sensitive sensor, not illustrated, so as to determine a load on the simulated pericardium 88 due to the trainee's operative procedure. This allows quantifying the load applied onto the simulated pericardium 88 by the surgery training and using it as one aspect of an objective evaluation of the training.

It is to be understood that the above-described embodiments are illustrative of only some of the many possible specific embodiments which can represent applications of the principles of the invention. Numerous and varied other arrangements can be readily devised by those skilled in the art without departing from the spirit and scope of the invention.

For example, it is permitted for said connector members to make use of other shapes such as a thin sheet shape as long as the same effect as the foregoing is achieved, regardless of the material of construction and the like, as long as it is a shape memory material contractible when an electric current is passed through.

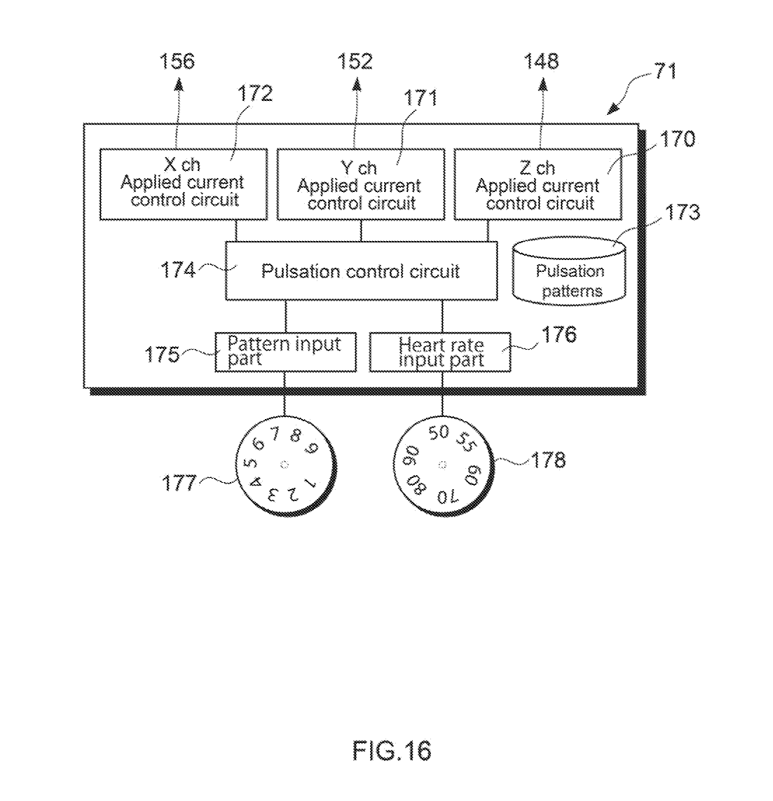

FIG. 16 is a schematic configuration view of the controller 71 connected to the drive unit.

This controller 71 comprises Z, Y, and X applied current control circuits, 170, 171, and 172 that are connected to each of wires 148, 152, and 156, respectively, which wires are provided at said Z, Y, and X stages, 147, 150, and 154; a pulsation pattern memory part 173 that stores a pulsation pattern generated by a combination of currents applied to each of wires 148, 152, and 156 by each of these Z, Y, and X applied current control circuits; a pulsation control circuit 174 that gives control signals to each of said Z, Y, and X applied current control circuits, 170, 171, and 172, based on said pulsation pattern; a pulsation pattern input part 175 that inputs a selection of the pulsation pattern; and a heart rate input part 176 that inputs a selection of the heart rate.

The pattern that can be input from the pattern input part 175 is such that 9 patterns, 1 to 9, can be selected with a dial 177. Each pattern in this embodiment is determined by a combination of amplitude and lag time given to each of Y and X wires, 152 and 156. The amplitude is the movement distance in the YX directions of the simulated blood vessel 89, which is given by the expansion and contraction of Y and X wires, 152 and 156, and it is provided in three patterns, 0, 1, and 2 mm, in this embodiment. The lag time is a lag time in current timing given to Y and X wires, 152 and 156 on the basis of the Z wire 148, and it is provided in three patterns, 0%, 10%, and 20% in this example. Therefore, the pulsation patterns that can be selected are 3×3, 9 patterns, the patterns being selectable with the dial 177. In addition, the selectable heart rate is so provided to allow the dial 178 to specify non-stepwise from 55 to 90 beats per minute. All the wires 148, 152, and 156 are so provided to be driven at a duty ratio corresponding to the selected heart rate.

The above-mentioned pulsation control circuit 174 is provided such that when the user specifies the pulsation pattern and heart rate using said two dials, 177 and 178, it determines, on the basis of said stored pulsation pattern 73, the voltages of the current and the duty ratios to be given to said ZYX wires, 148,152, and 156, whereby the pulsation is reproduced on the above-mentioned simulated blood vessel 89.

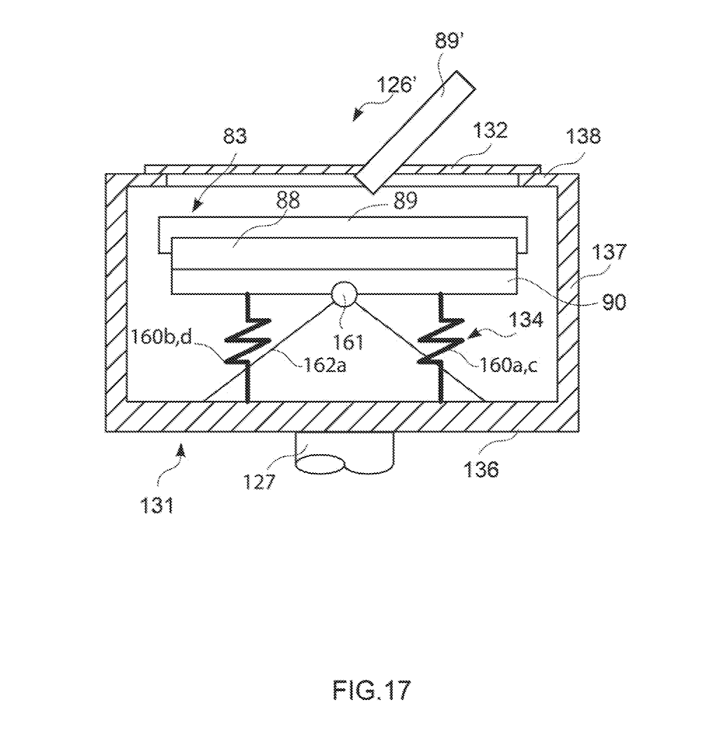

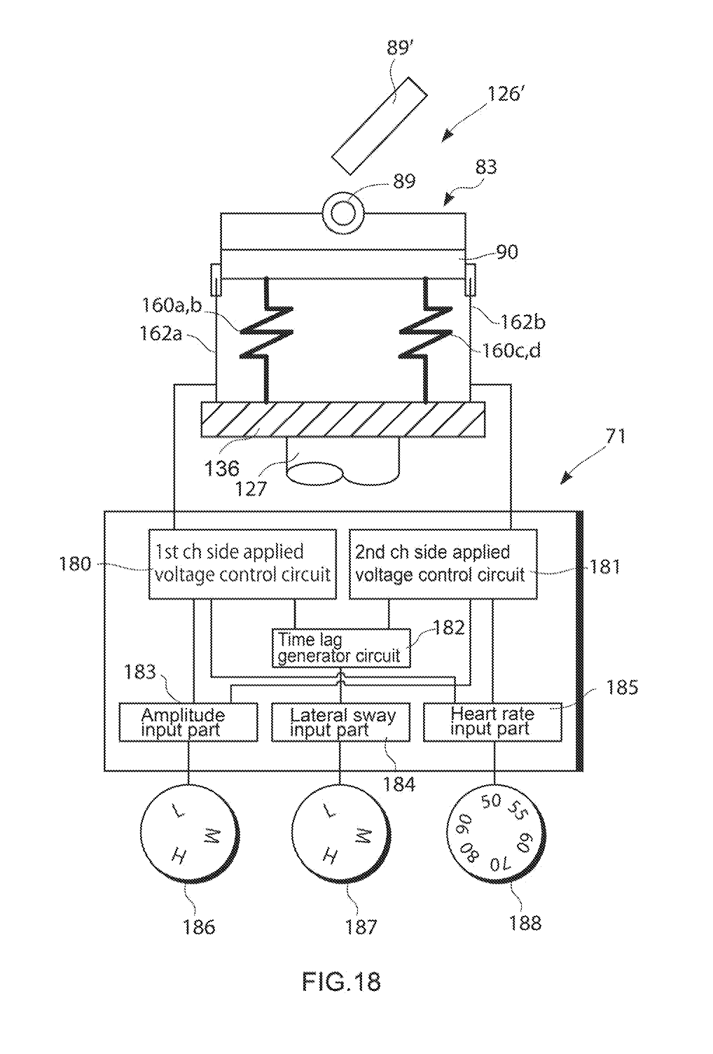

Yet, for another example, said drive unit may be as shown by a notation 126′ in FIGS. 17 and 18. This drive unit 126′ will be explained below except that the components in common with the drive unit 126 shown in FIGS. 14 and 15 will be assigned the identical notations and will not receive a detailed explanation therefor.

Herein, FIG. 17 is a view showing the condition of the drive unit 126′ as viewed from the lateral side of said simulated blood vessel 89; and FIG. 18 is a view showing the condition of the drive unit 126′ as viewed from the axial side of said simulated blood vessel 89. The drive mechanism 134 for this drive unit 126′ comprises four springs, 160a to 160d, for retention of retention plate 90 generally in parallel to a holder 131; a support shaft 161 that is provided at the lower end of said retention plate so as to cross in the across-the-width direction of said simulation body 83; and a left-and-right pair of wires 162a and 162b, the midway sections of which are fixated to the two ends of this support shaft 161, with both ends thereof being fixated to the above mentioned holder 131.

As evident from these Figures, in this drive mechanism 134, a pair of for-drive wires, 162a and 162b, are provided, in parallel to each other, at the two ends in the width direction of the above-mentioned holder 90, so as to be along the up-and-down direction (Z direction). In this respect the three wires, 148,152, and 156 in embodiments shown in FIGS. 14 and 15 were provided to bisect each other at right angles along the X, Y, and Z directions, and had three degrees of freedom; but examples in the FIGS. 17 and 18 show that the wires 162a and 162b are provided to be in parallel to each other and have two degrees of freedom.

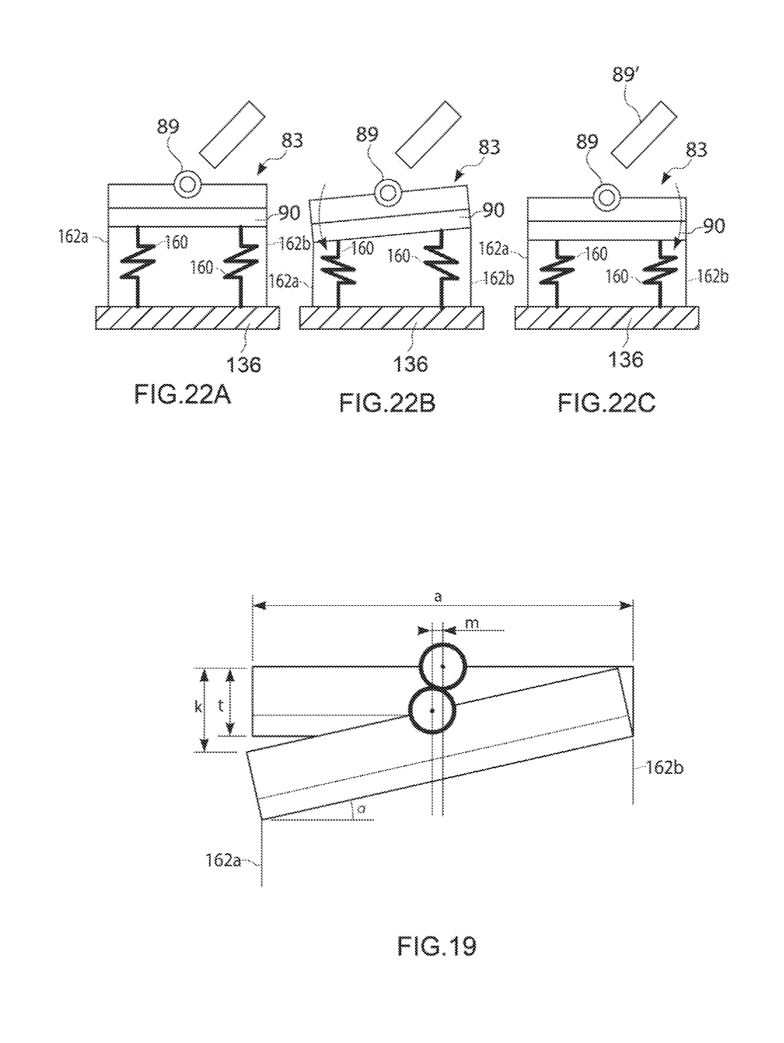

In such a two-degrees of freedom drive system in this embodiment, a pulsation in the horizontal direction in addition to the up-and-down direction is generated by letting the movement of one of wires 162a lag from that of the other wire, 162b. FIG. 22A to FIG. 22C are views showing the behavior of the simulation body 83 in this case. FIG. 19 is a schematic view for illustrating the movement distance of the above mentioned simulated blood vessel 89 in such a movement. The amount of movement, m, of the above mentioned simulated blood vessel 89 in the horizontal direction is determined by the following equation:

$$m = α ( \frac{1}{2} a sin α + t )$$

where a is the width of the simulation body 83; t is the distance from the height at which the wire is attached to the said simulated blood vessel 89; and k is the variation in the up and down direction of one of the wires, 162a, relative to the other wire, 162b.

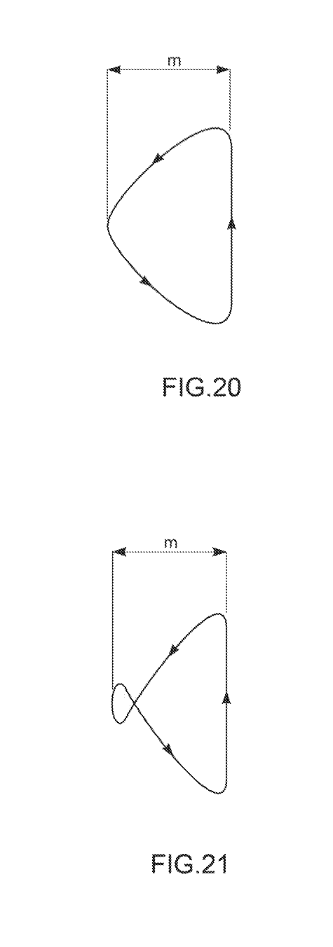

Thereafter, when the other wire 162b is allowed to move at the same duty ratio as that of one of the wires, 162a, with a 10% lag, said simulated blood vessel 89 will end up moving in an approximately triangular locus as shown in FIG. 20. In order to generate such movement in a horizontal direction, it is necessary that there be a difference (shown as size t in the figure) between the height at which this wire 162a (162b) is attached and the height of the simulated blood vessel 89, whereby the center position of the above-mentioned blood vessel 89 is offset, which enables reproducing a three-dimensional pulsation movement as shown in FIG. 20. The ratio of lag for the wires to achieve this is preferably 10 to 20%. It is also possible to let the movement to occur so as to draw an 8-shaped locus as shown in FIG. 21 by increasing the value of the above-mentioned t.

Next, the configuration of controller 71 connected to this drive mechanism 134 is explained in reference to FIG. 18.

This controller 71 comprises a 1st ch side applied voltage control circuit 180 and a 2nd ch side applied voltage control circuit 181 for driving said paired wires 162 a and 162b; and a time lag generator circuit 182 to provide a lag time to the timing of applying a current to the pair of wires 162a and 162, thereby generating a delay in movement between the wires 162a and 162b. In addition, this controller 71 is provided with three input parts, ie., an amplitude input part 183, a lateral sway input part 184, and a heart rate input part 185; and input dials, 186 to 188, are connected to the respective input parts 183 to 185. While the said 3-degres-of-freedom drive mechanism had a configuration which called for choosing one of the nine predetermined patters, this embodiment is provided to allow the user to individually select, and set up, the amplitude and lateral sway. It is so provided to allow inputting stepwise, that is, to input the heart rate: non-stepwise from 50 beats to 90 beats; the amplitude: high (3 mm), medium (2 mm), and low (1 mm); and the lateral sway: high (20% lag time), medium (10% lag time), and low (0% lag time). This gives pulsation patterns that can be expressed, amounting to 3×3=9 patterns.

Such configuration is advantageous in that a complex pulsation behavior can be generated by a simple wire configuration of two degrees of freedom.

Furthermore, an example was shown above where the surgery training unit 13 of the above-mentioned embodiment and modified example was used to carry out an anastomotic procedure training that involved suturing, to a part of the midway vessel wall of the simulated blood vessel 89, one end of a new simulated blood vessel 89′ thereby turning each of blood vessels, 89 and 89′ into a bifurcated Y-shape, followed by applying a pulsating flow thereto for an evaluation, as a way to evaluate the said anastomosis site. However, without being limited to this, an anastomosis can be easily evaluated by connecting an infusion-like static pressure load device, which is not illustrated, to the other end of a new simulated blood vessel 89′ and positioning said static pressure load device higher than the anastomosis site followed by feeding a designated liquid into the simulated blood vessel 89 gravitationally from the static pressure load device, thereby having the pressure loss detected by the pressure gauge P installed in the downstream side and the amount of the liquid passing through the anastomosis site. In this case the pressure applied to the anastomosis site can be readily and freely adjusted by varying the height of the static pressure load device, without using a pump or the like.

It is also envisioned to replace said simulation body 83 with the hearts of pigs, cows, goats, sheep, rabbits, and the like to be held on the object to be treated 75 as a training object and to make the entire heart pulsate in any manner with the action of said surgery training unit 13, whereby animal blood vessels are used to perform procedures such as anastomosis and the like on said blood vessels. Although surgery training using animal organs has heretofore been performed under static environments, this also enables conducting surgery training using real animal organs under any dynamic environment, so that improvements in surgery training effects can be expected and this also permits appropriate training evaluations.

Also, the system for evaluating training 1 related to the present embodiment can be applied not only to said coronary bypass surgery training and evaluation, but also to the training and evaluations of other cardiac surgeries involving procedures on the blood vessels.

In addition, the constitution of each part of the device in the present invention is not limited to the illustrated constitutional examples, and various changes are envisioned as long as substantially the same effects are achieved.

1. (canceled)

2. (canceled)

3. (canceled)

4. (canceled)

5. A device for evaluating a quality of a vascular surgery technique of a user comprising a first simulated blood vessel and a second simulated blood vessel, the device configured to:
position the first simulated blood vessel at a position opposing the second simulated blood vessel,
provide a pulsating movement to the first simulated blood vessel to enable the user to anastomose the second simulated blood vessel onto a site on the first blood vessel having the pulsation movement,
provide a simulated blood flow into the first and second simulated blood vessels such that the simulated blood flow passes through the anastomotic site where the second simulated blood vessel has been anastomosed to the first simulated blood vessel, and
determine a pressure loss of the flow passing through the anastomotic site, the pressure loss representing an evaluation of the vascular surgery technique in the user's anastomosing of the second simulated blood vessel to the first blood vessel.

6. The device of claim 5 further comprising:
a case arranged to lay out a simulated body cavity with a base and a frame installed above the base to enable a user to access the body cavity.

7. The device of claim 5, further configured to:
compare the pressure loss with a predetermined threshold value for the evaluation of the quality of the anastomotic site.

8. The device of claim 7, wherein said predetermined threshold value is a level for which a thrombus formation can be induced.

9. The device of claim 5, further configured to:
hold the second simulated blood vessel, in a position that enables the user to anastomose its one end with the first simulated blood vessel at midway in a longitudinal direction of the first blood vessel,
wherein a simulated blood fluid flows from the other end of the second simulated blood vessel to one end of the first simulated blood vessel through the anastomotic site where the first and second simulated blood vessels have been anastomosed by the user.

10. The device of claim 9,
wherein the pressure loss of the fluid is determined by a pressure gauge mounted downstream of the simulated blood fluid flow passing the anastomotic site.

11. A method for evaluating a quality of a vascular surgery technique of a user using a device having a first simulated blood vessel and a second simulated blood vessel, the method comprising the steps of:
positioning the first simulated blood vessel at a position opposing the second simulated blood vessel,
providing a pulsating movement to the first simulated blood vessel to enable the user to anastomose the second simulated blood vessel onto a site on the first blood vessel having the pulsation movement,
providing a simulated blood flow into the first and second simulated blood vessels such that the simulated blood flow passes through the anastomotic site where the second simulated blood vessel has been anastomosed to the first simulated blood vessel, and
determining a pressure loss of the flow passing through the anastomotic site, the pressure loss representing an evaluation of the vascular surgery technique in the user's anastomosing of the second simulated blood vessel to the first blood vessel.

12. The method of claim 11, further comprising the step of:
comparing the pressure loss with a predetermined threshold value for the evaluation of the quality of the anastomotic site.

13. The method of claim 12, wherein said predetermined threshold value is a level for which a thrombus formation can be induced.

14. The method of claim 11, further comprising the step of:
holding the second simulated blood vessel, in a position that enables the user to anastomose its one end with the first simulated blood vessel at midway in a longitudinal direction of the first blood vessel, and
feeding a simulated blood fluid flows from the other end of the second simulated blood vessel to one end of the first simulated blood vessel through the anastomotic site where the first and second simulated blood vessels have been anastomosed by the user.

15. The method of claim 14,
wherein the pressure loss of the fluid is determined by a pressure gauge mounted downstream of the simulated blood fluid flow passing the anastomotic site.
